(19) United States
(12) Patent Application Publication
(10) Pub. No.: US 2006/0290028 A1
(43) Pub. Date: Dec. 28, 2006

(54) Process for manufacturing a monolithic fan cowl

(75) Inventors: Joaquin Gallego Pleite, Madrid (ES); Jose Luis Fauste Duque, Madrid (ES); Luis Rubio Garcia, Cadiz (ES)

Correspondence Address: LADAS & PARRY, 26 WEST 61ST STREET, NEW YORK, NY, 10023, US

(73) Assignee: EADS CONSTRUCCIONES AERONAUTICAS, S.A.

(21) Appl. No.: 11/134,857

(22) Filed: May 20, 2005

(30) Foreign Application Priority Data
Mar. 30, 2005 (EP) 05381016.4

(51) Int. Cl. B32B 37/00; B29C 70/44

(52) U.S. Cl. 264/258; 264/324

(57) ABSTRACT

Process for manufacturing a monolithic fan cowl (9) of curvilinear shape for aircraft engines comprising the following steps:
a) providing a skin (1) cured, several longitudinal hat frames (3) uncured and several transversal hat frames (5) cured;
b) placing said longitudinal hat frames (3) on the skin (1)
c) placing said transversal hat frames (5) over the longitudinal frames (3) and the skin (1); d) covering the assembly with a vacuum bag;
e) performing an autoclave cycle under high temperature and pressure conditions for co-bonding the skin (1) and the longitudinal hat frames (3), and for a secondary bonding of the transversal hat frames (5) to the skin (1) and the longitudinal hat frames (3).

### FIELD OF THE INVENTION

The invention relates to the manufacture of a monolithic fan cowl of composite material for aircraft engines using high temperature consolidation processes.

### BACKGROUND

Known fan cowls for aircraft engines are made of the following materials: metallic structures, composite sandwich structures and composite or hybrid monolithic structure.

Classical processes for manufacturing fan cowls use uncured composite materials, which makes these processes complex and with high tolerances in final surfaces.

On the other hand, composite sandwich structures have the problem of water entries that degrade the adhesive.

One example of a monolithic structure is disclosed in WO 99/26841 (Aerospatiale Société Nationale Industrielle). The fan cowl is a panel having a network of axial and circumferential beams, which is manufactured draping composite material on a mold having the shape of the panel to be obtained and baking to polymerize.

This invention is intended to provide an improved method of manufacturing a monolithic fan cowl of composite materials.

### SUMMARY OF THE INVENTION

To accomplish this objective, the present invention provides a process for manufacturing a monolithic fan cowl assembling a cured skin, several uncured longitudinal hat frames and several cured transversal hat frames of composite materials and performing an autoclave curing cycle for co-bonding the skin and the longitudinal hat frames and for a secondary bonding of the transversal hat frames to the skin and the longitudinal hat frames.

In a preferred embodiment the longitudinal hat frames have an omega cross-section and the autoclave curing cycle includes, in addition to the vacuum bag covering the assembly, a tubular vacuum bag inserted into each longitudinal hat frame.

This process allows the manufacture of a fan cowl as an integral element in a shorter time than in the known art.

### BRIEF DESCRIPTION OF DRAWINGS

The features, objects and advantages of the invention will become apparent by reading this description in conjunction with the accompanying drawings, in which:

FIG. 1 is a schematic view of the manufacturing process of a fan cowl for aircraft engines according to this invention.

FIG. 2 is a perspective view of the tooling used for the manufacture of the fan cowl skin.

FIG. 3 is a perspective view of the tooling used for the lay-up of the fan cowl longitudinal hat frames.

FIG. 4 is a perspective view of the tooling used for the manufacture of the fan cowl transversal hat frames.

FIG. 5 is a perspective view of the tooling used for the transportation of the longitudinal fresh hat frames.

FIG. 6 is a perspective view of the tooling used for curing the skin and the fan-cowl assembly.

FIG. 7 is a schematic cross-section view of the assembly of the fan-cowl components before the curing step.

### DETAILED DESCRIPTION OF PREFERRED EMBODIMENTS

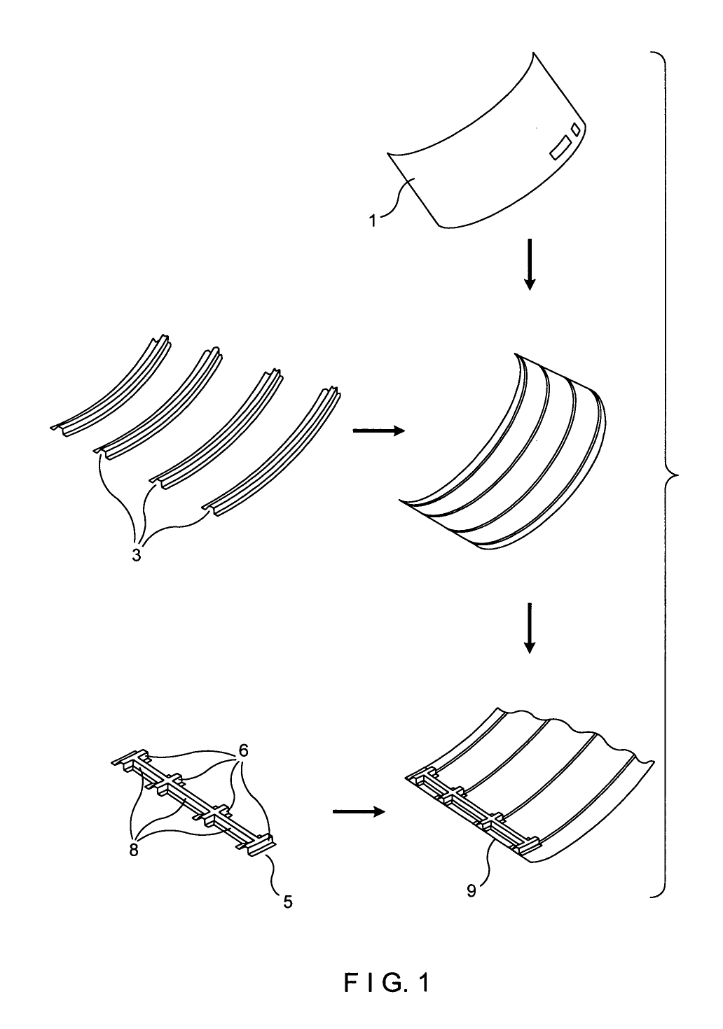

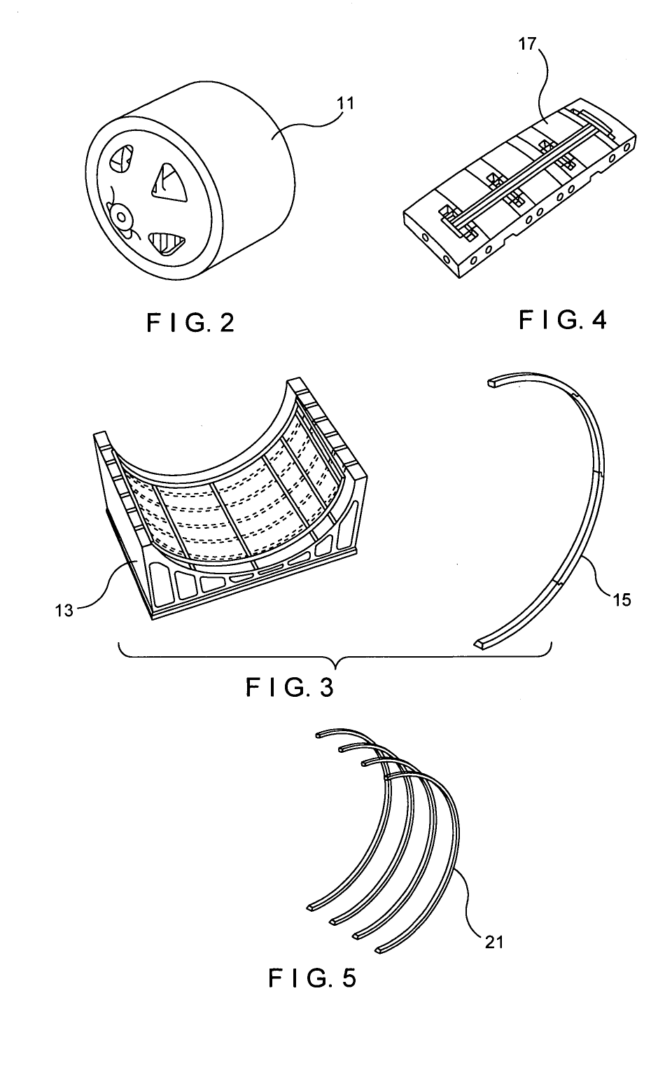

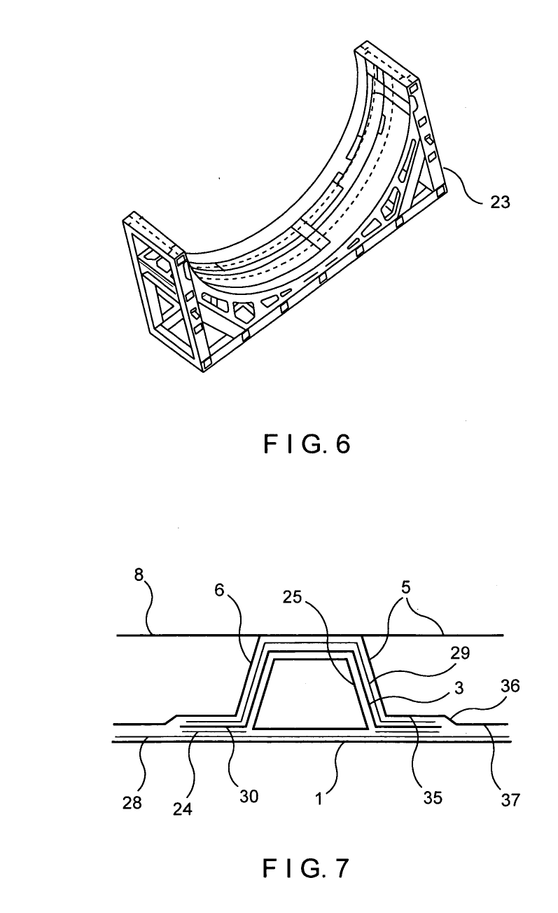

As schematically illustrated in FIG. 1 the process for manufacturing a monolithic fan cowl 9 of curvilinear shape for aircraft engines consists of assembling longitudinal hat frames 3 and transversal hat frames 5 over the skin 1.

The skin 1 and the transversal hat frames 5 are cured subcomponents while the longitudinal frames are uncured subcomponents. The whole assembly is then cured.

The manufacturing process of the skin 1 comprises the following steps:

Automate fiber-placement of carbon fiber prepreg on to a male tool or mandrel 11. Left and right fan-cowl skins 1 for one engine are made at the same time.

Hand lay-up on mandrel 11 of metallic mesh (for lightening protection).

Cutting (left and right fan-cowls skins 1) and unloading parts from mandrel 11.

Locating each part (left and right fan-cowls skins 1) on curing tool 23.

Peel-ply hand lay-up on inner face of fan-cowls skins 1.

Vacuum bagging.

Autoclave curing (90 PSIG, 180° C.).

Deburring.

Inspection and testing.

The manufacturing process of the transversal hat frames 5 comprises the following steps:

Hand lay-up on female tool 17 of carbon fiber prepreg.

Vacuum bagging

Autoclave curing (90 PSIG, 180° C.).

Trimming and deburring.

Inspection and testing.

As illustrated in FIGS. 1 and 7, transversal hat frames 5 are formed by parts 8 joined to parts 6 to be superimposed over the longitudinal hat frames 3 having all of them an omega cross-section like the longitudinal hat frames 3. Parts 6 include a first zone 35 to be superimposed over the foots 30 of the longitudinal hat frames 3, a second zone 37 to be superimposed over the skin 1 and a transitional zone 36 between them.

The preparation of the longitudinal hat frames 3 comprises the following steps:

Hand lay-up of prepreg carbon fiber on to male tools 15 placed over tools 13 having the same shape than the skin 1.

Vacuum debulking.

Turn over and unload the longitudinal hat frames 3 from male tools 15 using special covers 21 for transportation.

Insert tubular vacuum bags 25 into each longitudinal hat frame 3.

Adhesive 24 hand lay-up on inner foot face.

The assembly of the fan-cowl 9 comprises the following steps:

Locating skin 1 on autoclave tool 23.

Hand lay-up of adhesive and glass fiber prepreg 28 on the inner face of the skin 1

Locating longitudinal hat frames 3 with transportation covers 21 and internal vacuum bags 25 over skin 1 using a special bridge tooling (not shown) for controlling their position.

Remove the transportation covers 21

Adhesive 29 hand lay-up on longitudinal hat frames 3.

Locating transversal hat frames 5

Locating covers for the curing process

Vacuum bagging.

Autoclave curing (90 PSIG, 180° C.). In this step longitudinal hat frames 3 and skin 1 are co-bonded. Skin 1 and transversal hat frames 5 are subject to a secondary bonding.

Trimming.

Inspection and testing.

Painting

Final inspection

Although the present invention has been fully described in connection with preferred embodiments, it is evident that modifications may be introduced within the scope thereof, not considering this as limited by these embodiments, but by the contents of the following claims.

1. Process for manufacturing a monolithic fan cowl (9) of curvilinear shape for aircraft engines assembling a skin (1), several longitudinal hat frames (3) and several transversal hat frames (5) of composite material, characterized by including the steps of:
a) providing said skin (1) cured, said longitudinal hat frames (3) uncured and said transversal hat frames (5) cured;
b) placing said longitudinal hat frames (3) on the skin (1)
c) placing said transversal hat frames (5) over the longitudinal frames (3) and the skin (1);
d) covering the assembly with a vacuum bag;
e) performing an autoclave cycle under high temperature and pressure conditions for co-bonding the skin (1) and the longitudinal hat frames (3), and for a secondary bonding of the transversal hat frames (5) to the skin (1) and the longitudinal hat frames (3).

2. Process for manufacturing a monolithic fan cowl (9) according to claim 1, wherein the longitudinal hat frames 3 have an omega cross-section.

3. Process for manufacturing a monolithic fan cowl (9) according to claim 2, wherein an additional vacuum bag (25) inserted into each longitudinal hat frame (3) is used during the autoclave cycle.

4. Process for manufacturing a monolithic fan cowl (9) according to claim 2, wherein the transversal hat frames (5) are formed by parts (8) joined to parts (6) to be superimposed over the longitudinal hat frames (3), having all of them an omega cross-section.

5. Process for manufacturing a monolithic fan cowl (9) according to claim 4, wherein the foots (33) of said parts (6) include a first zone (35) to be superimposed over the foots (30) of the longitudinal hat frame (3), a second zone (37) to be superimposed over the skin (1) and a transitional zone (36) between them.
